(19) United States
(12) Patent Application Publication
(10) Pub. No.: US 2014/0069973 A1
(43) Pub. Date: Mar. 13, 2014

(54) Universal Fit Tablet Computer, Smartphone, Electronic Device Holding Display Unit that Fits onto Grocery or Shopping Carts

(71) Applicants: Robert Michael Peck, Queensbury, NY (US); Charles Bauer, East Greenbush, NY (US); Matthew Killian Carruthers, Saratoga Springs, NY (US)

(72) Inventors: Robert Michael Peck, Queensbury, NY (US); Charles Bauer, East Greenbush, NY (US); Matthew Killian Carruthers, Saratoga Springs, NY (US)

(21) Appl. No.: 13/615,376

(22) Filed: Sep. 13, 2012

(51) Int. Cl. B60R 11/02

(52) U.S. Cl. CPC B60R 11/02
USPC 224/411

(57) ABSTRACT

This device will hold tablet computers, smart phones, or electronic devices in a manner that the user can see the device while it is being held on the handle of a shopping cart or grocery cart by means of a rear assembly. It will hold the electronic devices on the front and clip to grocery carts by means of a rear assembly on the back which can be modified to accommodate retailer specific cart designs when necessary.

### BACKGROUND OF THE INVENTION

The present invention relates to a device that holds tablets, smartphones, and Wi-Fi devices in a way that allows easy display while shopping by attaching to a shopping or grocery cart. This device will allow for mobile applications to be used while shopping. Some examples of benefits are direct target coupon programs, location services, store mapping, entertainment for kids, health watch programs, etc.

### DESCRIPTION OF PRIOR ART

The general idea of having a holder for your tablet, smart phone, or electronic devices is not new however the specific use of this invention is revolutionary and unknown in prior art or patent descriptions. The following represent similar holders noted and further support our case for this new inventions patentability.

1. U.S. Pat. App. Pub. No. US2012/0024918A1 by Ron Decamp and Mark Thoni in 2012

2. U.S. Pat. No. US D653,668S Issued to Song and Faik in 2012

3. U.S. Pat. No. US D652,836S Issued to Voorhees in 2012

4. U.S. Pat. App. Pub. No. US2010/0294908A1 by Mish, Ward, Ashley in 2009

5. U.S. Pat. No. USD641,610S by Sedalo in 2010

The above examples are all much different than this invention. No holding device has been created to clip on to grocery carts or shopping carts for our claimed use.

To this point no electronic device holders have been integrated for the sole purpose of holding modern technological devices such as personal computing tablets, smart phones, PDA's, and Wi-Fi eBook readers on shopping devices to allow a shopper or browser specific access to technology while shopping. This invention has incorporated a universal fit design for multiple types of electronic devices to be securely placed in a location that allows for easy viewing on the handle of a grocery or shopping cart.

### SUMMARY OF THE INVENTION

The device is comprised of the following;
A solid single piece made of high strength modern polymer which allows for easy holding of an electronic device
Integral self-clip attaching to the handle bar of a grocery cart.
A possible non-slip coating or strategic insert that allows for steady placement of device.
A possible bottom clamp or interchangeable clips with screw mount holes for permanent or semi-permanent fixation to a wider variety of carts.

When combined these pieces come together to form a tablet, smart phone, electronic device holder/viewer that will universally attach to a grocery cart handle and allow for easy viewing of the screen. This device will be approximately 11 inches tall by 8.5 inches wide and 5-8 inches deep. It will utilize modern high strength polymers to create a strong frame capable of repeat consumer use. A smaller unit designed to fit smaller electronics such as smart phones and PDA's is also claimed.

This invention was created with simplicity in mind. It is being created to be the simplest and most efficient universal way to securely fasten the electronic device to a grocery cart with easy viewing. All attributes discussed could be necessary to the function of this invention.

This devices primary use will be for consumers to take advantage of electronic applications to provide an upgraded shopping experience.

This invention may come in an array of similarly fashioned shapes, colors, and sizes to accommodate retailer preferences and specifications.

A person would use this invention by purchasing the unit, bringing to store, and attaching to a grocery or shopping cart to take advantage of electronic upgraded shopping experiences brought typically but not limited to mobile applications using Wi-Fi and/or cell phone data services. A person could also use this invention by borrowing, renting, and/or utilizing in store units specifically made for use by the consumer at the expense of the retailer.

After a professional patent search this invention incorporates a revolutionary design, idea, and use that has not been patented or brought to market yet. The invention differs from any other patented product for this use by being able to universally clip onto grocery cart handles to view electronic devices.

### BRIEF DESCRIPTION OF THE DRAWING

FIG. 1 illustrates the view from the front and side of the tablet/phone holder and shows the cavities where each would slide into place when mounted on a shopping cart.

FIG. 2 illustrates a view from the back of the device and shows the portion of the device that could universally clip onto the handle of a shopping cart.

FIG. 3 shows a front and side view of a similarly designed electronic device holder and a different type of universal clipping part.

FIG. 4 shows front and side view of a smaller electronic device holder and a possible method of easily removing device from unit.

### DETAILED DESCRIPTION OF THE EMBODIMENTS

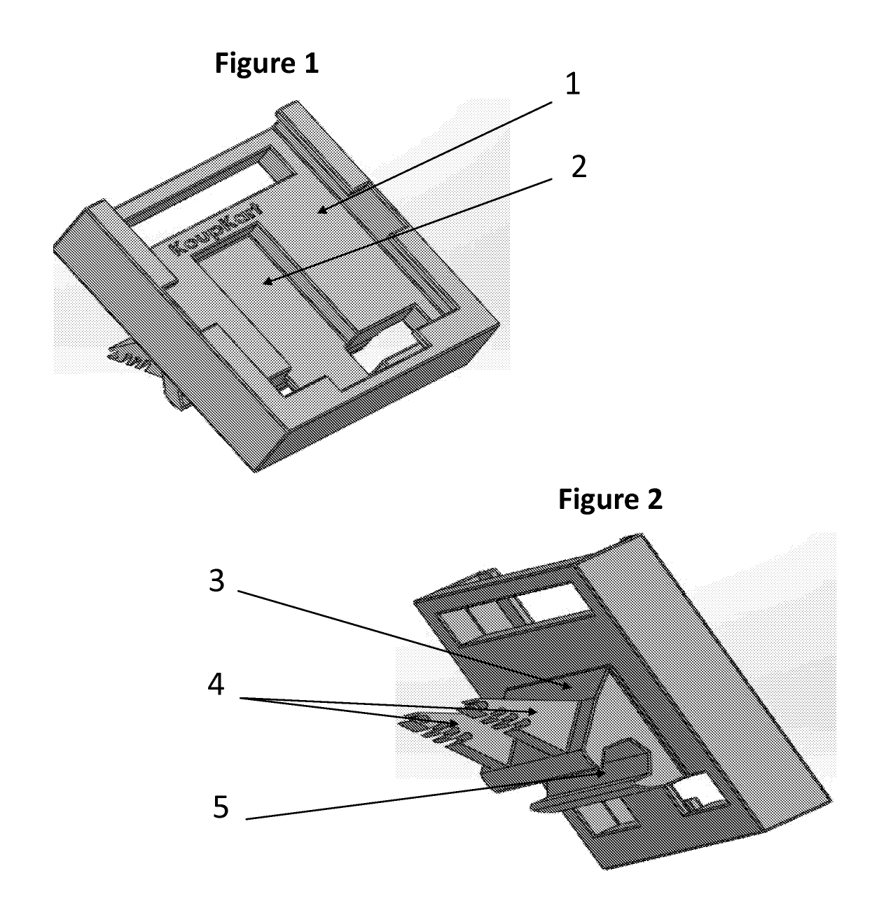

As shown in FIG. 1 the invention has a front area 1 that would allow a tablet computer to be inserted from the top and a front area 2 where smaller devices such as smart phones can be inserted to allow for easy viewing and function of the devices. In this drawing you can see the way electronic devices can be inserted into the invention to be viewed by a shopper. Also being claimed are similar looking inventions that serve the same major function that would allow for different designs based on retailers custom specifications.

As shown in FIG. 2 the invention has a rear integral or assembled part 3 where the invention would be securely fastened to a grocery or shopping cart. The rear assembly 3 has universal or retailer unique design so that the support arm 4 would set onto the cart frame arid with slight pressure the handle clip device 5 would snap into place on the handle of a grocery or shopping cart. In this drawing you can see one way the invention can be secured to a grocery cart. Other methods being claimed are permanent screw on rear assemblies, cart specific rear assemblies, and more advanced rear assemblies to allow for more versatile used of this invention.

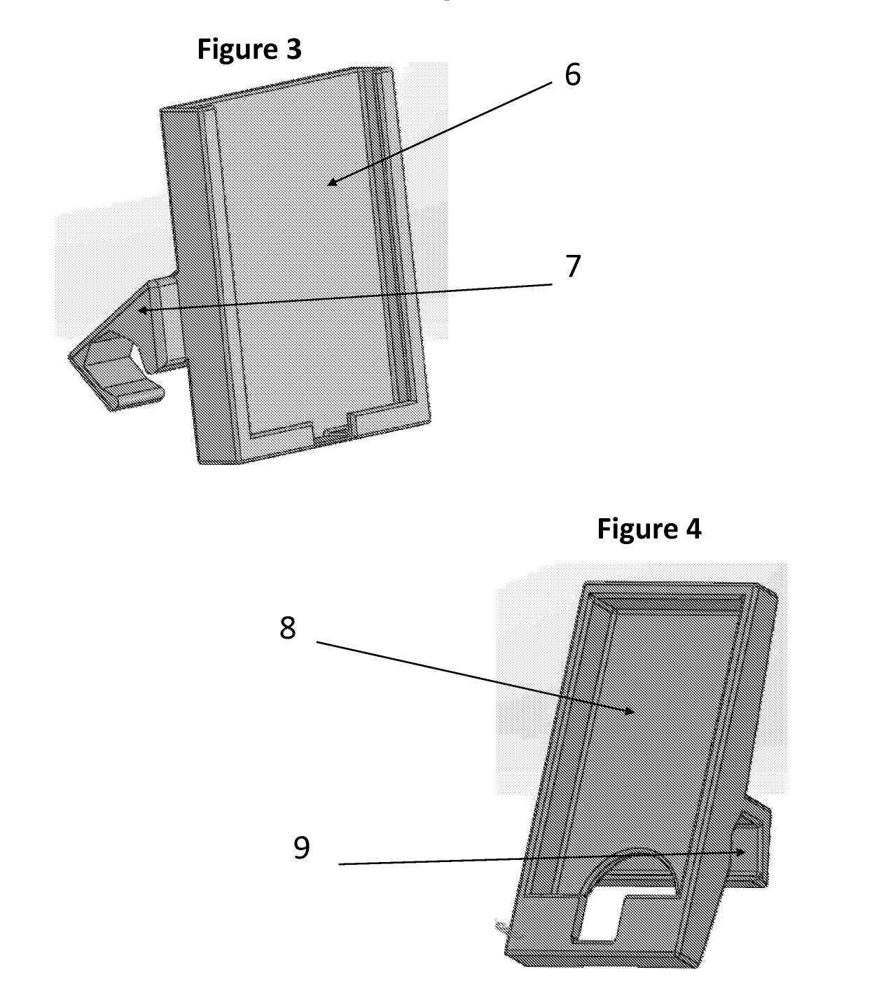

FIG. 3 shows a similar tablet holder design 6 with a simpler cart clasp mechanism 7 for fastening onto a cart.

FIG. 4 shows a smaller design made for a smaller device such as a smart phone with a front portion 8 for holding the device and a clasping mechanism 9.

1. A portable electronic device holding unit adapted to engage a frame support of an object such as the handle bar of a grocery cart, the electronic device holding unit comprising of a front component and a back component secured to the front component, the front component and the back component defining a method to secure device to grocery cart.

2. The electronic device holding unit as recited in claim 1, wherein the front component is comprised of a rectangular housing having recesses adapted to receive electronic equipment.

3. The electronic device holding unit as recited in claim 1, wherein the front component allows larger devices to slide into front component.

4. The electronic device holding unit as recited in claim 1, wherein the back component adapted to clip onto the handle bar or frame support.

5. The electronic device holding unit as recited in claim 1, wherein the back component allows the device to be positioned and secured to the frame support.
